(19) United States
(12) Patent Application Publication
(10) Pub. No.: US 2012/0212648 A1
(43) Pub. Date: Aug. 23, 2012

(54) CAMERA SYSTEM

(76) Inventor: Koji Oka, Machida-shi (JP)

(21) Appl. No.: 13/504,367

(22) PCT Filed: Nov. 9, 2010
(86) PCT No.: PCT/JP2010/070252

§ 371 Date: Apr. 26, 2012

(30) Foreign Application Priority Data
Nov. 9, 2009 (JP) 2009-255925
Jun. 24, 2010 (JP) 2010143917

(51) Int. Cl. H04N 5/76

(52) U.S. Cl. 348/231.99; 348/E05.031

(57) ABSTRACT

A camera system includes a main body unit having a storage unit configured to store image data outputted from an image pickup device, a display unit configured to display the image data, and an attachment section to which an external unit is detachably attached, and a lens unit having an optical lens and an image pickup device, the lens unit being attachable as the external unit to the attachment section, the image pickup device configured to capture subject light having passed through the optical lens, and to output the subject light as image data, the external unit is provided with a control program to function the main body unit as a master or a slave for the external unit.

### TECHNICAL FIELD

The present invention relates to a camera system, particularly to a camera system configured such that a lens unit is detachably attached to a camera main body.

### BACKGROUND ART

Conventionally, a camera system, in which a lens unit is detachably attached to a main body unit, has been known. Among such camera systems, there has been proposed a camera system in which an external unit other than a lens unit, such as a printer, a liquid crystal projector, or a data converter is connectable to the main body unit (for example, see Japanese Patent Application Laid-open Publication No. 2000-92358).

In the camera system of Japanese Patent Application Laid-open Publication No. 2000-92358, an interchangeable lens, which is a lens unit, is attached to a mounting section of the main body unit. Here, the camera system is configured to allow an external unit to be attached to the main body unit via the mounting section, and can perform data communication with the external unit without having the main body unit provided with special connection or a communication unit. Thus, an increase in size and cost of the camera system can be avoided.

In the above-mentioned conventional camera system, the mounting section is provided with a communication terminal and image data is transferred to the external unit from the main body unit via the communication terminal. However, it is unknown how the external unit is controlled.

In a camera system in which an external unit other than the lens unit such as a printer, a liquid crystal projector, or a data converter is connectable to the main body unit, the main body unit is required to have an operational program for functioning as a master if the main body unit serves as a master of the external unit, or as a slave if the main body unit serves as a slave of the external unit.

The above-mentioned operational program is stored in a memory of the main body unit. If the main body unit is connectable to several types of external units including several types of interchangeable lenses, the main body unit must store as many operational programs as those several types. In order to store those several types of operational programs, a large capacity of memory is needed. Thus, high costs are involved. Also, each time a new product as an external unit including an interchangeable lens is released, the main body unit has to be updated to install a new operational program therein. Accordingly, much time and effort are involved in this case.

The above description is provided for the case of a camera system in which an external unit other than the lens unit such as a printer, a liquid crystal projector, or a data converter is connectable to the main body unit; however, the same holds true for the case of a camera system in which only several types of interchangeable lenses as an external unit are connectable to the main body unit. That is to say, the main body unit must store as many operational programs as those several types of interchangeable lenses, thus requiring a large capacity of memory and involving high costs. Also, each time a new type of interchangeable lens is released, the main body unit is required to be updated, which requires much time and effort as well. Also, in the update of the program, when the main body unit has an operational program for an interchangeable lens, upgrade of the version of a program needs upgrading of both of the operational program stored in the main body unit and the program stored in the interchangeable lens, for which much time and effort are involved as well. Furthermore, a case may occur where the version of the operational program stored in the main body unit is different from that of the program stored in the interchangeable lens. In this case, incompatibility between the versions may cause a problem that the main body unit has troubles in communication with the interchangeable lens or control of the lens even through running the program thereon.

### SUMMARY OF THE INVENTION

An object of the present invention is to provide a camera system in which an external unit other than a lens unit is connectable to a main body unit, and which is capable of operating by using a memory of the main body unit having a capacity made as small as a required minimum capacity, without needing installation of the an operational program for a new external unit or the like in the main body unit.

In order to solve the aforementioned problem, an embodiment of the present invention provides a camera system comprising: a main body unit having a storage unit configured to store image data outputted from an image pickup device, a display unit configured to display the image data, and an attachment section to which an external unit is detachably attached; and a lens unit having an optical lens and an image pickup device, the lens unit being attachable as the external unit to the attachment section, the image pickup device configured to capture subject light having passed through the optical lens, and to output the subject light as image data, wherein the external unit is provided with a control program to function the main body unit as a master or a slave for the external unit.

An embodiment of the present invention also provides a main body unit comprising: an attachment section to which a lens unit of a camera is detachably attached; a storage unit configured to store image data outputted from an image pickup device provided in the lens unit; a display unit configured to display the image data; and an operation unit configured to switch the image data displayed on the display unit, wherein various external units instead of the lens unit are attachable to the attachment section; and a control program to function the main body unit itself as a master or a slave for each of the external units including the lens unit is loaded from the external unit.

An embodiment of the present invention also provides an external unit that is detachably attached to an attachment section of a main body unit of a camera, wherein the external unit stores a control program to function the main body unit as a master or a slave for the external unit itself.

An embodiment of the present invention provides a control method for a camera system in which a lens unit including an image pickup device is detachably attached to an attachment section of a main body unit; various external units instead of the lens unit are attachable to the attachment section; and each of the external units including the lens unit stores a control program to function the main body unit as a master or a slave for the external unit, the method comprising, upon attachment of each of the external units to the attachment section, loading the control program from the external unit, thereby starting an operation according to the control program.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1A is a perspective view of a camera system attached with a lens unit with a single focus according to an embodiment of the present invention.

FIG. 1B is a perspective view of a camera system attached with a lens unit with an optical zoom according to an embodiment of the present invention.

FIG. 2 is an overall block diagram of a lens unit and a main body unit.

FIG. 3 is a block diagram of a lens unit according to another example.

FIG. 4 is a block diagram of a lens unit according to still another example.

FIG. 5 is a perspective view of a camera system attached with a hard disk unit as an external unit.

FIG. 6 is a perspective view of a camera system attached with a printer unit or a scanner unit as an external unit.

FIG. 7 is a perspective view of a camera system attached with a projector unit as an external unit.

FIG. 8 is a perspective view of a camera system attached with a wireless waterproof camera unit as an external unit.

FIG. 9 is a block diagram of a hard disk unit, a printer unit, a scanner unit, a projector unit, or a wireless waterproof camera unit.

FIG. 10 is a flowchart showing operations of a main body unit.

FIG. 11 is a flowchart showing operations of the main body unit according to Example 1.

FIG. 12 is a diagram showing an example of unit information of the external unit according to Embodiment 1.

FIG. 13 is a diagram showing an example of unit information of a main body unit.

FIGS. 14A, 14B show the characteristic features of the camera system compared with the conventional technology; FIG. 14A is a diagram showing internal configurations of the main body unit and each external unit in the conventional technology, and FIG. 14B is a diagram showing internal configurations of the main body unit and each external unit in Embodiment 1.

FIG. 15 is a flowchart showing operations of a main body unit according to Embodiment 2.

FIG. 16 is a diagram showing an example of unit information of the external unit according to Embodiment 2.

FIG. 17 is a diagram showing internal configurations of the main body unit and each external unit in Embodiment 2.

FIG. 18 is a diagram showing internal configurations of the main body unit and each external unit in Embodiment 3.

### DETAILED DESCRIPTION OF THE PREFERRED EMBODIMENTS

In the following, Embodiments of the present invention are described according to the drawings.

### Embodiments

### Embodiment 1

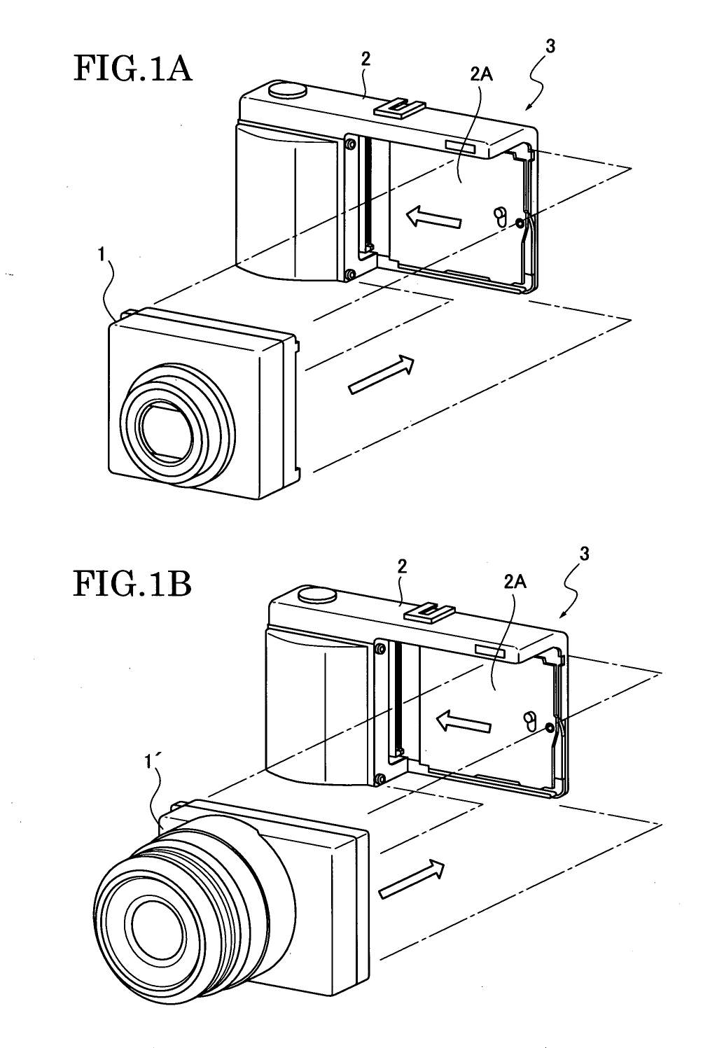

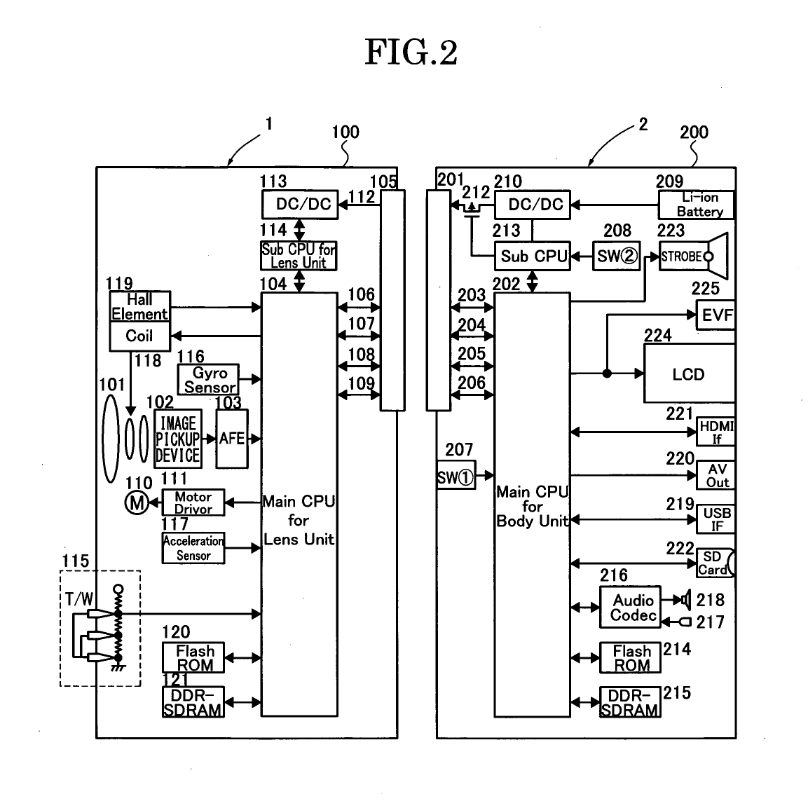

Each of FIGS. 1, 2 shows an example of the camera system according to the embodiment of the present invention. In each of FIGS. 1, 2, a camera system 3 includes a main body unit 2 which is the camera main body, and a lens unit 1 (or 1′) which can be detachably attached to an attachment section 2A of the main body unit 2. The camera system 3 serves as an image pickup apparatus with the main body unit 2 and the lens unit 1 (or 1′) integrated. The lens unit is selected from various types by a user as needed to be attached to the attachment section 2A of the main body unit 2, and is, for example, the lens unit 1 with a single focus (FIG. 1A), or the lens unit 1 with an optical zoom (FIG. 1B).

Next, the functional configuration of the camera system according to the embodiment of the present invention is described using FIGS. 2 to 4. FIG. 2 is a diagram showing the functional block of the main body unit 2 and the lens unit 1 with a single focus lens that are included in the camera system 3 according to the embodiment of the present invention.

In FIG. 2, a lens unit section 100 showing the functional block of the lens unit 1 includes: a lens group 101 provided with focus lenses; an image pickup device 102 that converts a subject image received via lens group 101 from a light signal to an electrical signal to be outputted; an AFE (Analog Front End) 103 that converts the signal outputted from the image pickup device 102 (analog image data) to digital image data to be amplified; and a CPU104, so-called image engine that performs predetermined image processing such as conversion processing to YUV data, compression processing in JPEG format, and RAW data generation processing on the converted digital image data.

Also, the lens unit section 100 includes a joint connector 105 that forms an interface between units to be electrically connected to the main body unit 2; a bi-directional bus 106 to transmit image data to the main body unit 2 via this joint connector 105; and signal lines to receive a control signal 107, a serial interface signal 108, an SDIO signal 109, respectively.

Also, the lens unit section 100 includes a motor driver 111 to control a motor 110 used for extending and retracting the barrel of the lens group 101. The motor driver 111 is controlled by the control signal 107 received from the main body unit 2. This mechanism enables various operation controls such as retracting the barrel according to the type of the interchangeable lens when the power supply for the camera system 3 is turned off, or variable power operation by pressing a button (not shown).

Also, the lens unit section 100 includes: a DC-DC converter 113 to generate various electric power needed for the operation of the lens unit section 100 from an electric power 112 supplied from the main body unit 2; a sub-microcomputer 114 to detect the electric power 112 supplied from the main body unit 2 and thereby to control the DC-DC converter 113; and a detection circuit 115 to detect a tele-converter lens and a wide converter lens that are attachable to the exterior of the lens unit section 100.

Also, the lens unit section 100 includes a gyro sensor 116 to detect a tilt of the camera system 3; an acceleration sensor 117 to detect an acceleration applied to the camera system 3; a coil 118 to drive the lens group 101 according to the tilt detected by the gyro sensor 116 and the acceleration detected by the acceleration sensor 117; and a hall element 119 to detect a drive quantity of the coil 118. By the gyro sensors 116, the acceleration sensor 117, the coil 118, and the hall element 119, the image stabilization function is implemented.

Furthermore, the lens unit section 100 is configured such that a flash ROM 120 stores software to perform image processing and operation control processing, and the processing by this software is executed by the CPU 104 using a RAM 121, which is a work area, and the CPU 104 performs the operation of each mechanism and the processing control.

In FIG. 2, a main body unit section 200 showing a functional block of the main body unit 2 includes: a joint connector 201 that forms an interface between units to be electrically connected to the lens unit section 100; a bi-directional bus 203 to transfer image data received from the lens unit section 100 via the joint connector 201 to a CPU 202; the CPU 202, so-called image engine that performs a conversion processing to YUV data, compression processing in JPEG format, expansion processing from JPEG format, and RAW data generation processing as needed on the image data received via the bi-directional bus 203; a line of control signal 204 to be connected to the line of the control signal 107 of the lens unit section 100; a line of serial interface signal 205 to be connected to the line of the serial interface signal 108 of the lens unit section 100; and a line of SDIO signal 206 to be connected to the line of the SDIO signal 109 of the lens unit section 100.

Also the main body unit section 200 includes a focus and release switch 207 that is a switch to start a shooting operation of the camera system 3 by a predetermined pressing operation; a switch 208 that includes a cross key used for selection setting of an operational mode of the camera system 3, which is set in the main body unit section 200; and a sub-microcomputer 213 that detects an input to the switch 208 and performs predetermined setting processing, also controls, using a DC-DC converter 210, the power supplied from a lithium-ion battery 209, and controls an electric power switch 212 which is a switch for supplying electric power to the lens unit section 100.

In addition, the lens unit section 200 is configured such that a flash ROM 214 stores software to perform image processing and operation control processing, and the processing by this software is executed by the CPU 202 using an SDRAM 215, which is a work area, and the CPU 202 performs the operation of each mechanism and the processing control.

Also, the main body unit section 200 includes: an audio codec 216; a microphone 217 to input an audio signal to the audio codec 216; a loudspeaker 218 to output sound from the audio codec 216; a USB interface connector 219; an AV output connector 220; an output interface 221 for HDMI signal; an SD memory 222 which is a detachably attachable storage unit for storing a shot image file; a strobe 223 to serve also as a connection circuit used when an external strobe is attached to the main body unit section 200; an LCD 224 and EVF 225 that are a display unit to display a subject image on a monitor by an operation of the focus and release switch 207 at the time of a focusing operation, and to display a shot image data at the time of a shooting operation.

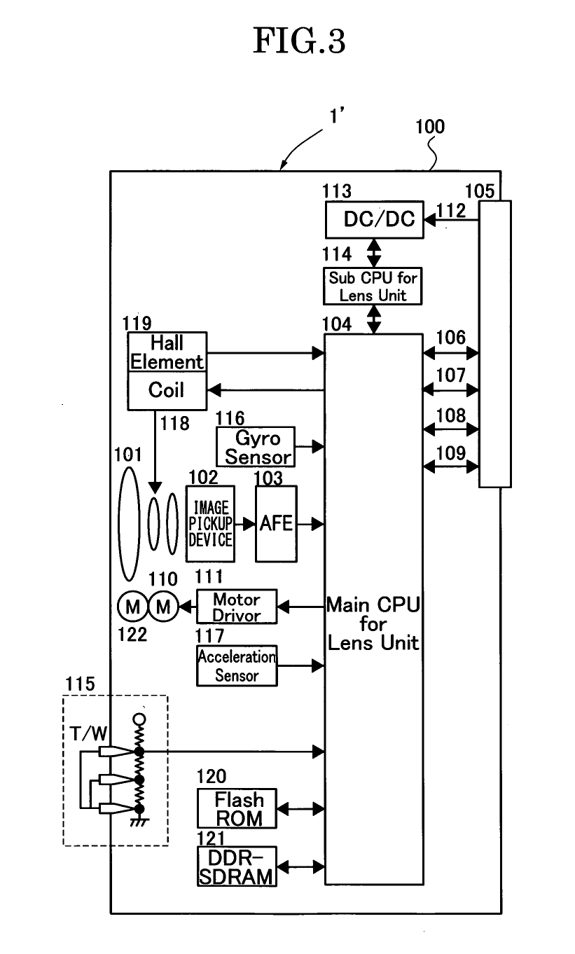

FIG. 3 is a functional block diagram showing another example of the lens unit section 100 (functional block of the lens unit 1′ mounted with an optical zoom). In the lens unit section 100 shown in FIG. 3, the lens group 101 has a zoom function, and a motor for zoom 122 to move the lens group 101 is provided. And, by an operation of a zoom switch (not shown) provided in the main body unit section 200, predetermined operations can be performed on the focus lenses and the zoom lenses provided in the lens group 101. Other configuration is the same as that of the lens unit section 100 shown in FIG. 2.

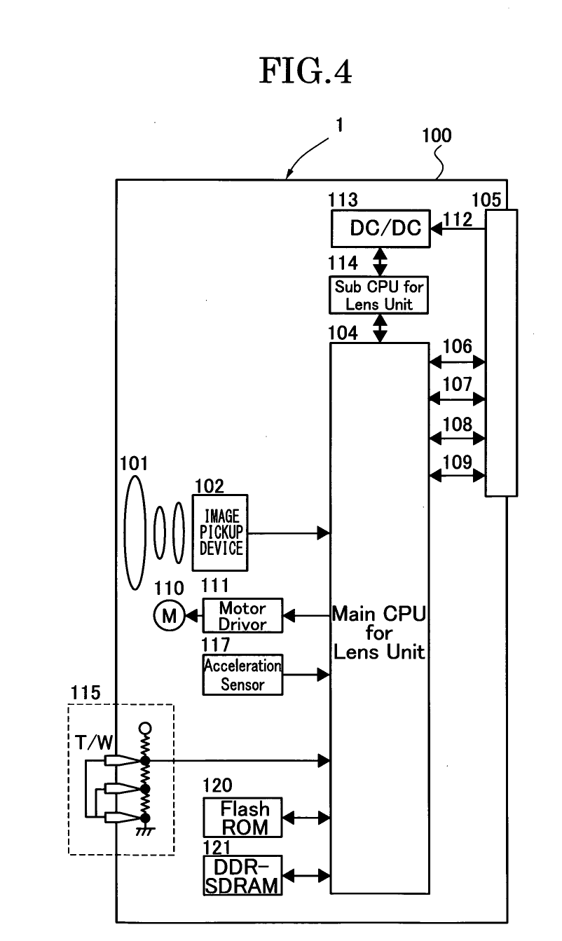

FIG. 4 is a functional block diagram showing still another example of the lens unit section 100. In lens unit section 100 shown in FIG. 4, a configuration corresponding to the hall element 119, the coil 118, and the gyro sensor 116 (see FIG. 2 for each) that perform an image stabilization function is eliminated by increasing the size of the image pickup device 102. Other configuration is the same as that of the lens unit section 100 shown in FIG. 2.

In the camera system shown in FIG. 1 described above, instead of the lens unit section 100 shown in FIG. 2, the lens unit section 100 shown in FIG. 3, or the lens unit section 100 shown in FIG. 4 can be attached to the attachment section 2A of the main body unit 2. Also, instead of the lens unit section 100, other external units (for example, a hard disk unit, a printer unit, a scanner unit, a projector unit, and the like) can be attached to the attachment section 2A of the main body unit 2.

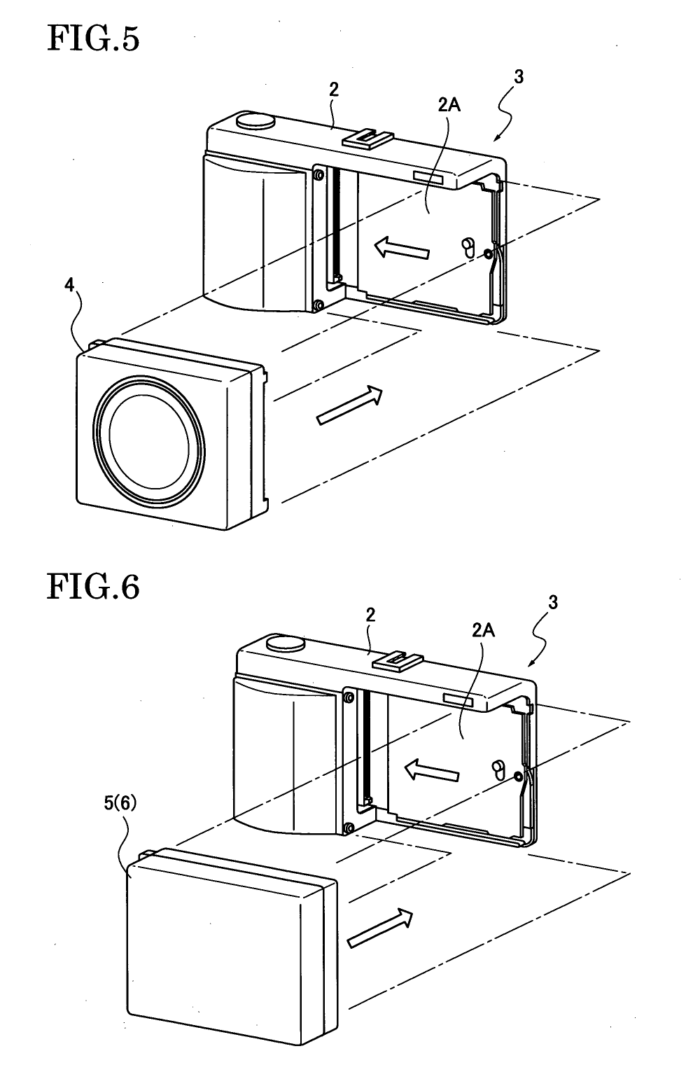

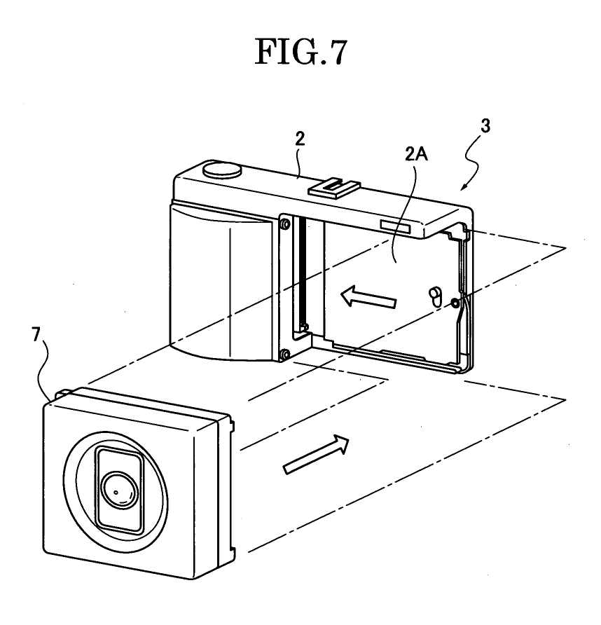

FIG. 5 shows how a hard disk unit 4 is attached to the attachment section 2A of body unit 2, and FIG. 6 shows how a printer unit 5 or a scanner unit 6 is attached to the attachment section 2A of the main body unit 2. Also, FIG. 7 shows how a projector unit 7 is attached to the attachment section 2A of the main body unit 2.

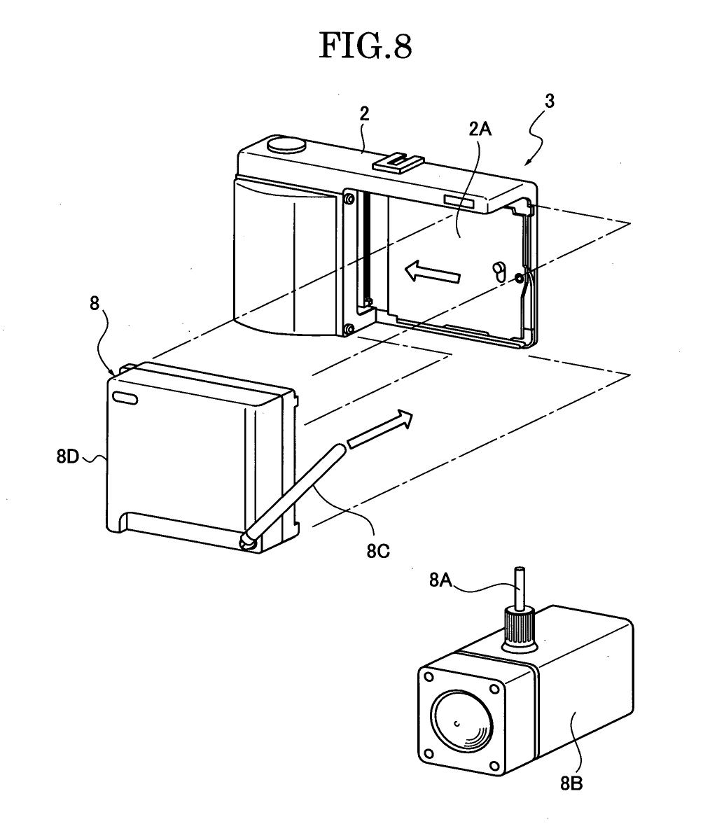

Furthermore, FIG. 8 shows how a wireless waterproof camera unit 8 is attached to the attachment section 2A of the main body unit 2. The wireless waterproof camera unit 8 includes a camera section 8B having an antenna 8A, which is provided with a camera installable in an outdoor situation, and a camera control section 8D having an antenna 8C, which performs transmission and reception to and from the camera section 8B. The camera control section 8D is attached to the attachment section 2A of the main body unit 2.

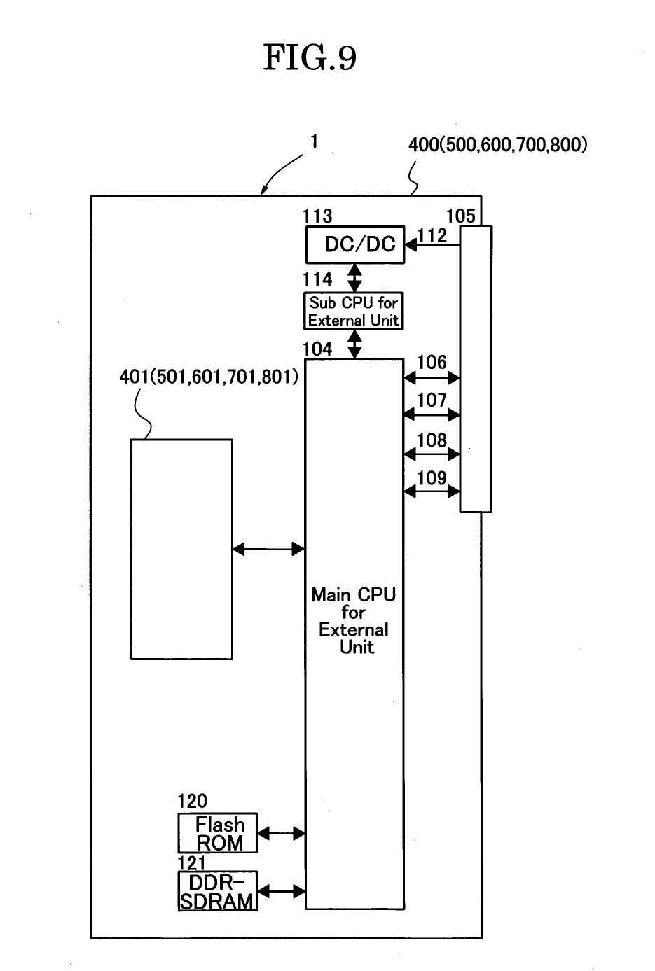

FIG. 9 shows an internal configuration of a hard disk unit section 400 indicating the functional block of the hard disk unit 4, a printer unit section 500 indicating the functional block of the printer unit 5, a scanner unit section 600 indicating the functional block of the scanner unit 6, a projector unit section 700 indicating the functional block of the projector unit 7, or a wireless waterproof camera unit section 800 indicating the functional block of the wireless waterproof camera unit 8.

In the case of the hard disk unit section 400, a hard disk main body 401 is provided therewithin, and is connected to the CPU 104 via a hard disk interface (not shown). In the case of the printer unit section 500, a printer main body 501 is provided therewithin, and is connected to the CPU 104 via a printer interface (not shown). Also, in the case of the scanner unit section 600, a scanner main body 601 is provided therewithin, and is connected to the CPU 104 via a scanner interface (not shown).

Also, in the case of the projector unit section 700, a projector main body 701 is provided therewithin, and is connected to the CPU 104 via a projector interface (not shown).

Furthermore, in the case of the wireless waterproof camera unit section 800, a wireless waterproof camera control section main body 801 is provided therewithin, and is connected to the CPU 104 via a wireless waterproof camera interface (not shown).

The main body unit 2, and the above-mentioned external units 1 and 4 to 8 have respective specification values for exchanging unit information with each other, and the main body unit 2 is configured to determine the type of the external unit attached to the attachment section 2A based on the specification value.

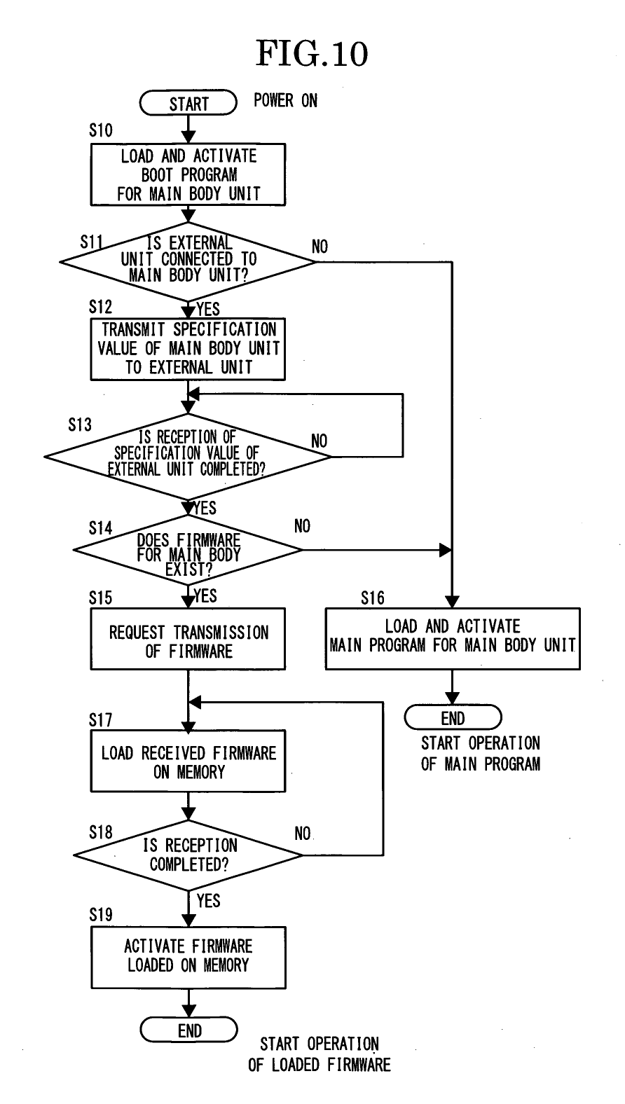

Next, the operations of Example 1 are described using FIGS. 10 to 14.

FIG. 10 is a flowchart showing the operations of the main body unit 2. When the power supply for the main body unit (camera main body) 2 is turned on, a boot program stored in the flash ROM 214 (see FIG. 2) is activated (step S10). This is one of general activation methods for a microcomputer.

Then the bi-directional bus 203 is checked to see whether an external unit (although the hard disk unit 4, the printer unit 5, etc. are included in external units, the external unit here is assumed to be the lens unit 1) is connected to the attachment section 2A of the main body unit 2 (step S11). If the external unit is connected to the attachment section 2A, first, the specification value of the unit itself (the main body unit) is transmitted to the external unit in order to exchange unit information between the main body unit and the external unit (step S12). The specification value of the main body unit is shown in FIG. 13.

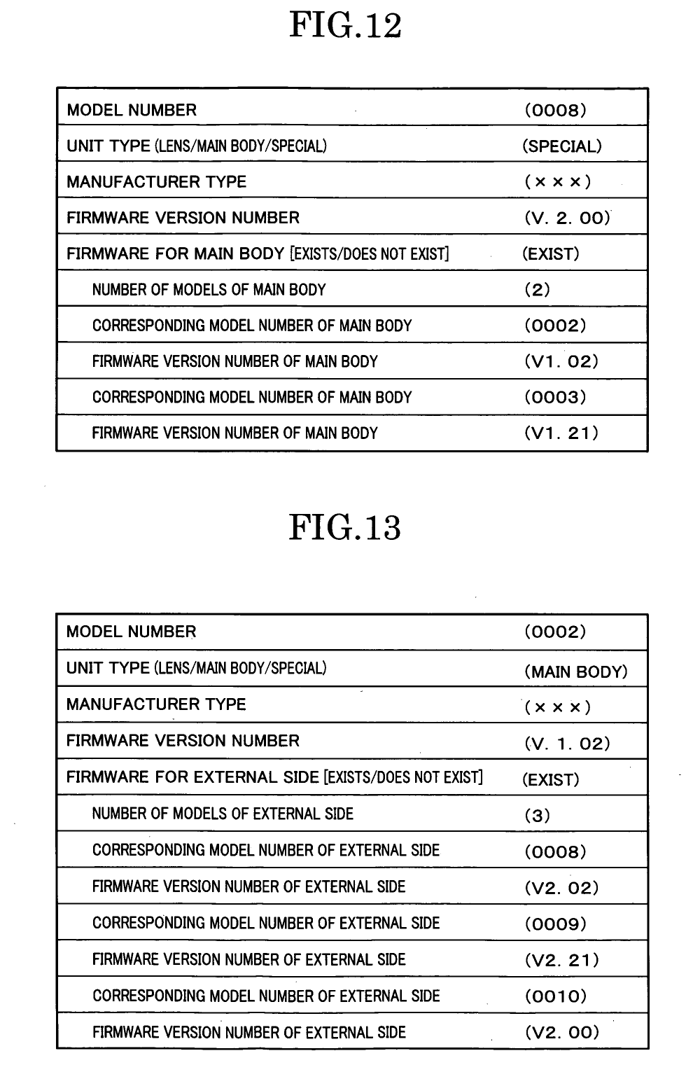

FIG. 12 shows an example of unit information of the external unit. This unit information has a model number, a unit type, a manufacturer type, a firmware version number, a firmware of the main body, and the number of models of the main body, which is 2 in this example, and the unit information has two types of corresponding model number of the main body and its firmware version number of the main body. What type of the unit itself is registered to the unit type. Embodiment 1 shows an example where the units are classified into three types: main body unit, the lens unit, and the special unit. Since external units include the ones such as a printer, a projector, storage, and a wireless LAN camera other than the lens unit, these units are classified as a special unit in this example.

The main body unit 2 receives the unit information (specification value) of the external unit, and determines whether the reception is completed or not (step S13). Then the main body unit 2 checks whether firmware information of the main body exists in the received unit information or not (step S14). If the firmware information of the main body exists, the main body unit 2 requests transmission of the firmware to the external unit (step S15). If the firmware information of the main body does not exist, the main body unit 2 loads and activates the main program stored in the flash ROM 214 (see FIG. 2) (step S16). Subsequently, the operation of the main program is started.

In step S15, after requesting the transmission of the firmware to the external unit, the main body unit 2 receives the firmware from the external unit, and loads the firmware on the SDRAM 215 (see FIG. 2) (step S17). After determining whether reception of all the firmware is completed or not (step S18), the main body unit 2 activates the firmware loaded on the SDRAM 215 (step S19), and starts its operation.

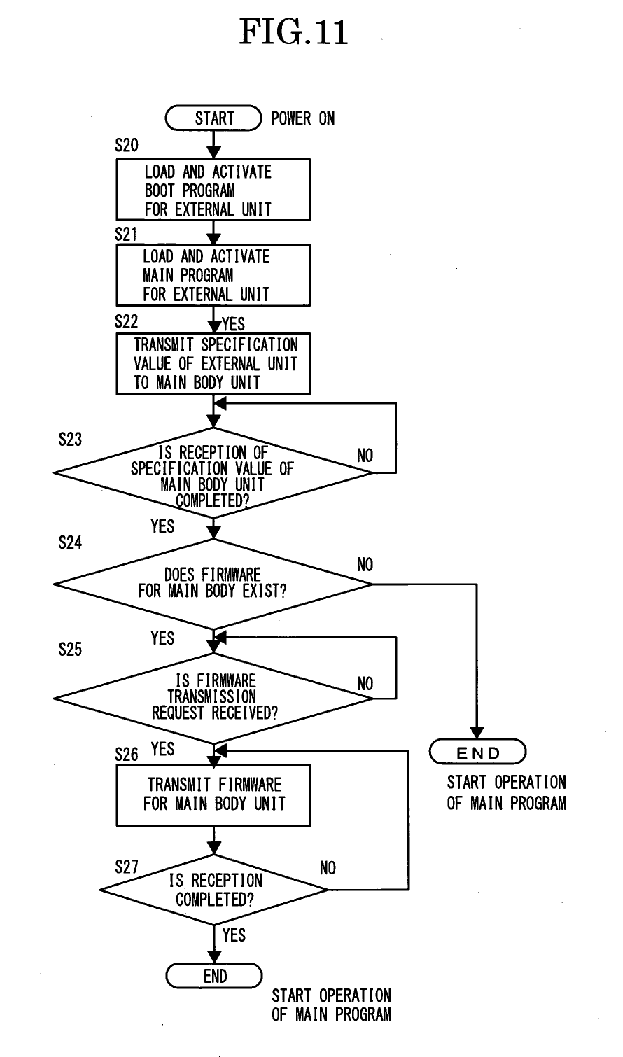

FIG. 11 is a flowchart showing the operations of the external units. When the power supply for the main body unit 2 is turned on, a boot program stored in the flash ROM 120 of the external unit (see FIG. 2) is activated (step S20). This is one of general activation methods for a microcomputer.

Then the main body unit 2 loads the main program stored in the flash ROM 120 to activate the external unit (step S21). At this stage, control for reducing the activation time such as extending the barrel of the lens may be performed, or such control processing may be performed later. Since such processing is related to the activation time, the control method may be changed to a control method suitable for the system.

Next, the specification value of the unit itself (the external unit) is first transmitted to the main body unit 2 through the bi-directional bus 106 in order to exchange unit information between the external unit and the main body unit 2 (step S22). The unit information at this point is the same as that shown in FIG. 12.

Also, the external unit receives the unit information (specification value) from the main body unit 2, and determines whether the reception is completed or not (step S23). The external unit checks whether the main body firmware corresponding to the information of the main body firmware in the received unit information exists in the flash ROM 120 of the external unit or not (step S24).

If the corresponding main body firmware does not exist in the flash ROM 120 of the external unit, execution of the main program is then started. If the corresponding main body firmware exists in the flash ROM 120 of the external unit, the external unit is on standby for receiving a firmware transmission request (step S25). After receiving a transmission request and confirming the synchronization of both units, the external unit loads the firmware of the main body from the flash ROM 120, and transmits the same (step S26). After completing the transmission, the external unit starts the execution of the main program and performs the subsequent processing of the external unit.

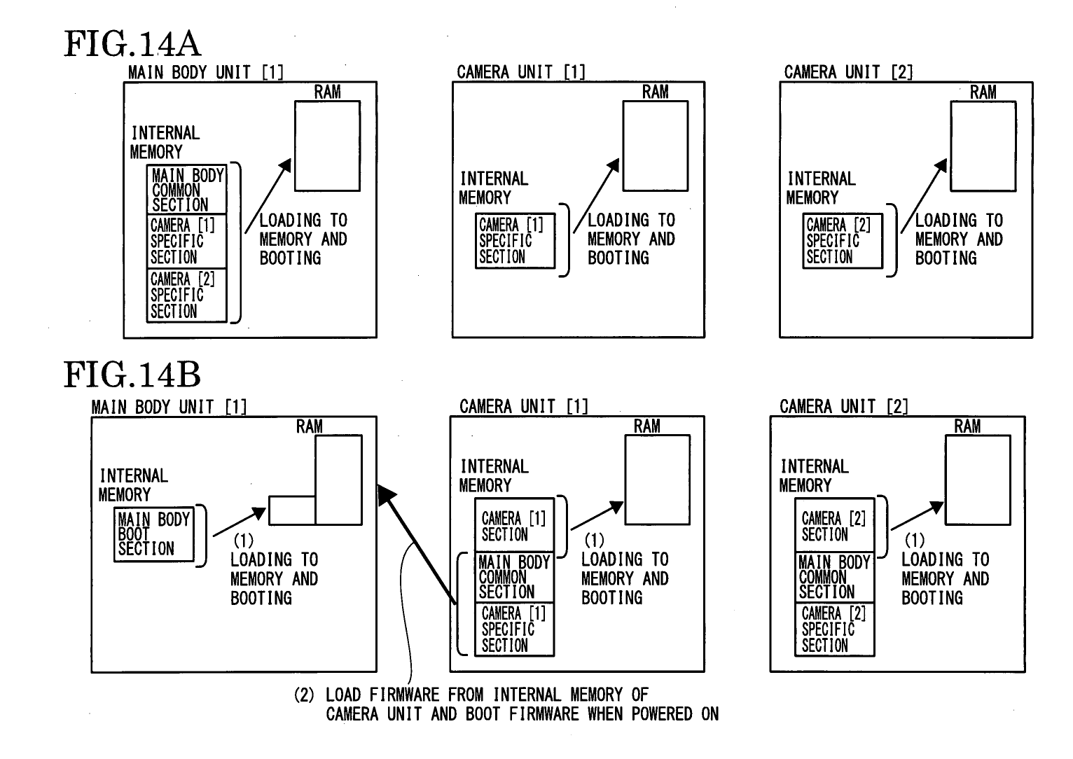

Each of FIGS. 14A, 14B shows the characteristic features of the camera system according to Embodiment 1 compared with the conventional technology, FIG. 14A shows internal configurations of a main body unit [1] and camera units [1] and [2], which are external units, in the conventional technology, and FIG. 14B shows internal configurations of a main body unit [1] and camera units [1] and [2], which are external units, in Example 1.

Conventionally, as shown in FIG. 14A, the main body unit [1] has an internal memory and a RAM, and the internal memory is provided with a main body common section, a camera [1] specific section, and a camera [2] specific section. Here, the main body common section stores the firmware for operating specific devices such as an operation section or a display section of the main body unit [1]. The camera [1] specific section stores the firmware specific to the camera unit [1], to which the display data, the operation sequence, and the like for the camera unit [1] are registered. The camera [2] specific section stores the firmware specific to the camera unit [2], to which the display data, the operation sequence, and the like for the camera unit [2] are registered.

The camera unit [1] has an internal memory and a RAM, and the internal memory is provided with a camera [1] section. The camera [1] section stores the firmware for the camera unit [1]. The camera unit [2] also has an internal memory and a RAM, and the internal memory is provided with a camera [2] section. The camera [2] section stores the firmware for the camera unit [2].

And when the power supply for the main body unit [1] is turned on with the camera unit [1] attached, in the main body unit [1], the information of the main body common section and the camera [1] specific section is boot-loaded into the RAM to activate the main body unit [1], while in the camera unit [1], the information of the camera [1] section is loaded into the RAM to activate the camera unit [1]. On the other hand, when the power supply for the main body unit [1] is turned on with the camera unit [2] attached, in the main body unit [1], the information of the main body common section and the camera [2] specific section is loaded into the RAM to activate the main body unit [1], while in the camera unit [2], the information of the camera [2] section is loaded into the RAM to activate the camera unit [2].

In this manner, with the conventional camera system, the firmware for the main body unit [1] (the control programs common to the camera units [1] and [2], the control program specific to the camera unit [1], and the control program specific to the camera unit [2]) is provided in the main body unit [1]. In addition, the firmware for the camera unit [1] and the firmware for the camera unit [2] are provided in the camera unit [1] and the camera unit [2], respectively. The pieces of firmware are thus distributed. Although the firmware of a specific section is configured to be registered to corresponding camera unit [1] or [2] as much as possible, a case necessarily occurs where the portion specific to the lens, such as no zoom for a short focus lens is left in the main body unit [1].

On the other hand, in Embodiment 1, as shown in FIG. 14B, the main body unit [1] has the internal memory and the RAM, and the internal memory is only provided with a main body boot section. Here, the main body boot section stores a boot program for activating the main body unit [1]. The configuration is such that if the main body unit [1] is activated alone without connecting the camera units [1] and [2] thereto, only replay function may be operated.

The camera unit [1] has the internal memory and the RAM, and the internal memory is provided with the camera [1] section, the main body common section, and the camera [1] specific section. The camera [1] section stores the firmware for the camera unit [1], which is the same as the one in FIG. 14A according to the conventional technology. Also the main body common section and the camera [1] specific section store the firmware of the main body unit [1].

The camera unit [2] has the internal memory and the RAM, and the internal memory is provided with the camera [2] section, the main body common section, and the camera [2] specific section. The camera [2] section stores the firmware for the camera unit [2], which is the same as the one in FIG. 14A according to the conventional technology. Also the main body common section and the camera [2] specific section store the firmware of the main body unit [1].

Upon attachment of the camera unit [1] to the main body unit [1], the main body unit [1] determines that the firmware for the main body unit [1] is installed in the camera unit [1] at the first specification value exchange, and loads the boot program from the main body boot section to the RAM to boot the main body unit [1]. On the other hand, in the camera unit [1], the firmware for the camera unit [1] is loaded from the camera [1] section to the RAM to boot the camera unit [1].

After the main body unit [1] and the camera unit [1] are activated, when the power supply is on, the firmware for the main body unit [1] is loaded from the main body common section and the camera [1] specific section in the camera unit [1] to the RAM in the main body unit [1] to start the operation as the camera system.

In addition, when the camera unit [2] is attached to the main body unit [1], the main body unit [1] determines that the firmware for the main body unit [1] is installed in the camera unit [2] at the first specification value exchange, and loads the boot program from the main body boot section to the RAM to boot the main body unit [1]. On the other hand, in the camera unit [2], the firmware for the camera unit [2] is loaded from the camera [2] section to the RAM to boot the camera unit [2].

After the main body unit [1] and the camera unit [2] are activated, the camera system starts its proper operations when being powered on by loading the firmware for the main body unit [1] from the main body common section and the camera [1] specific section in the camera unit [2] to the RAM in the main body unit [1].

In this manner, in the camera system of Embodiment 1, the pieces of the firmware for the main body unit [1] are installed to the camera unit [1] and the camera unit [2], respectively, thus reducing the distribution of the firmware.

According to Embodiment 1, each camera unit (each external unit) stores the firmware for the main body unit, the pieces of the firmware specific to all of the camera units which may be attached to the main body unit are not required to be stored in the main body unit. Thus, a large capacity of memory is not required. Also, even if a new camera unit is connected to the main body unit, the main body unit is not required to be pre-updated to store the firmware specific to the new camera unit to the memory. Accordingly, time and effort are saved. Version upgrade can be made only on the camera unit. Thus, complicated steps at the time of the version upgrade can be eliminated. Also, compatibility between the main body unit and the camera units is improved. Accordingly, flexibility of the combination of the main body unit and the camera units is increased.

Also, in Embodiment 1, the operational program provided in the camera unit is configured to include the operation application software for operating the relevant camera unit, and to cause the operation sequence and the display sequence to be operated independently. Thus, the main body unit can perform processing according to the function of the external unit, such as control of the display unit or control of the external unit according to an operation by the operation unit because the firmware received in step S17 of FIG. 10 is the main program of the main body unit.

### Embodiment 2

Although, in Embodiment 1, the firmware of the main body is (exists) in the unit information of the external unit shown in FIG. 12, in Embodiment 2, the case where the firmware of the main body is not (does not exist) in the unit information is described. In Embodiment 2, the branch of (NO) is selected in step S14 of the flowchart shown in FIG. 10, and the branch of (NO) is selected at step S24 of the flowchart shown in FIG. 11.

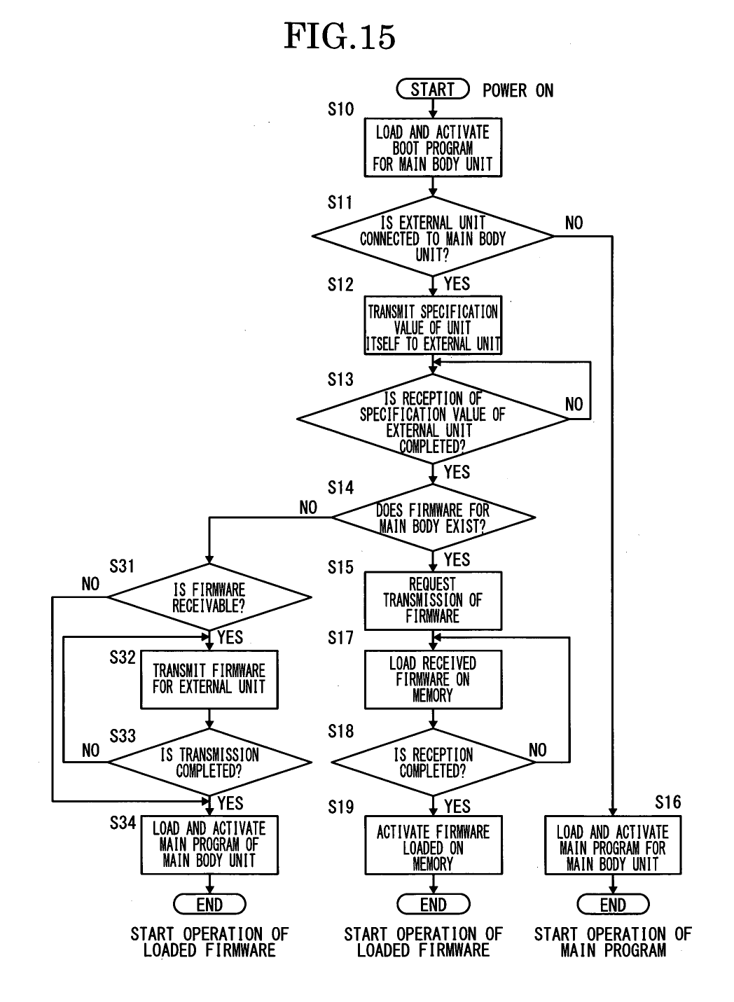

That is to say, the main body unit, if the firmware of the main body is not (does not exist) in the unit information received in step S14 as shown in FIG. 15, determines whether or not the relevant firmware of the external unit is registered in the main body unit using the model number of the external unit as reference information (step S31). Further, the external unit also determines whether the firmware of the external unit registered in the main body unit can be received or not (step S31).

If the external unit does not need to receive the firmware, the process proceeds to step S34. As shown in the table of FIG. 13, if the firmware of the external unit exists and the external unit can receive the same, the relevant firmware is read from the flash ROM 214 (see FIG. 2) and is transmitted to the external unit (step S32). When the transmission to all of the external units is completed (step S33), the main body unit reads the main program of the unit itself from the flash ROM 214 (see FIG. 2) to load the main program on the memory to activate the same (step S34).

In FIG. 15, the processing of steps S10 to S13 and steps S15 to S19 is the same as the case of FIG. 10. Thus, its description is omitted.

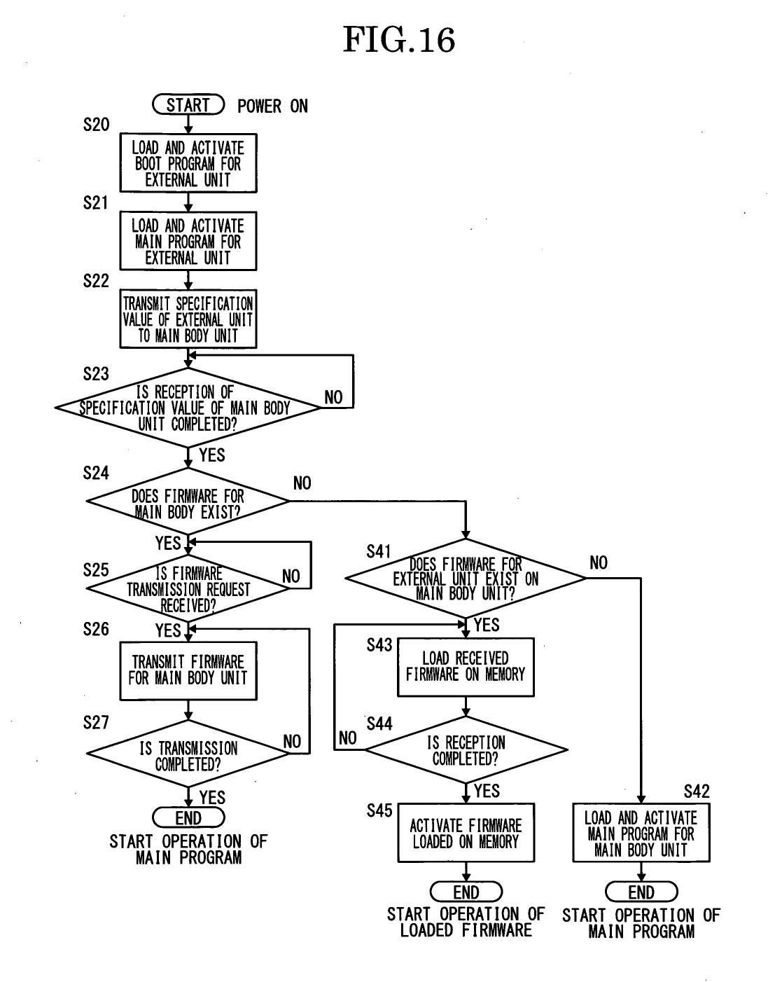

The external unit, if the firmware of the main body is not (does not exist) in the unit information received in step S24 as shown in FIG. 16, determines whether the model number of the unit itself (for example, 0008) is registered to the main body unit or not, i.e., whether the main body unit has the firmware of the external unit or not by using the information of FIG. 13 notified from the main body unit as reference information (step S41).

If the firmware of the external unit does not exist, the main program of the external unit (the unit itself) is read from the flash ROM 120 (see FIG. 2) to be loaded on the memory to activate the same (step S42). If the firmware of the external unit exists, the external unit receives the firmware from the main body unit to load the same on the RAM121 (see FIG. 2) (step S43). The external unit, when receiving all of the firmware (step S44), activates the firmware loaded on the RAM121 (step S45).

In step S14 of the flowchart shown in FIG. 15, the main body unit may determines whether the control program specific to the external unit is stored in the memory of the main body or not before determining whether the unit information of the external unit has the firmware of the main body or not. If the control program specific to the external unit is stored in the memory of the main body, no transmission of the firmware is needed because the firmware is not loaded from the external unit.

FIG. 13 shows an example of unit information of the main body unit. This unit information is an example showing the specification value of the main body unit, and indicates that the main body unit is provided with the firmware of the external units for three models. In this case, in step S24 of FIG. 16, the external units checks the model number of their units (for example, 0008) from the received information of the main body unit, and if the model number is in a unit information pattern, the branching process of NO can be made because the transmission of the firmware is not needed.

This unit information shown in FIG. 13 has a model number, a unit type, a manufacturer type, a firmware version number, a firmware of an external unit, and the number of models of the external side, which is 3 in this example, and the unit information has three types of corresponding model number of the external side and its firmware version number of the external side.

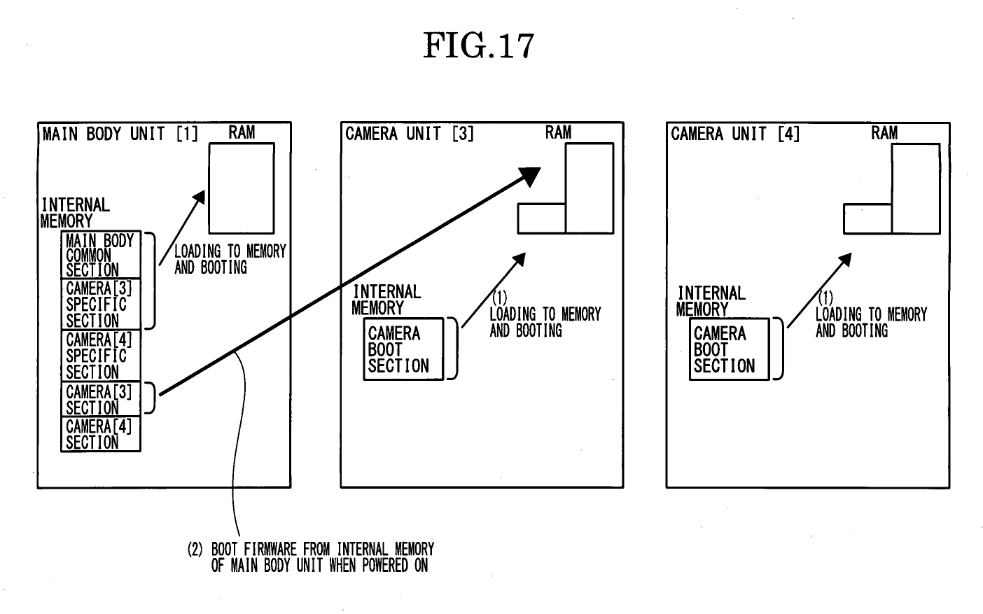

FIG. 17 shows the characteristic features of the camera system according to Embodiment 2, and shows the respective internal configurations of a main body unit [1] and camera units [3] and [4], which are external units.

The main body unit [1] has an internal memory and a RAM, and the internal memory is provided with a main body common section, a camera [3] specific section, a camera [4] specific section, a camera [3] section, and a camera [4] section. Here, the main body common section stores the firmware for operating specific devices such as an operation section or a display section of the main body unit [1]. The camera [3] specific section stores the firmware specific to the camera unit [3], to which the display data, the operation sequence, and the like for the camera unit [1] are registered. The camera [4] specific section stores the firmware specific to the camera unit [4], to which the display data, the operation sequence, and the like for the camera unit [4] are registered. Also, the camera [3] section stores the firmware for the camera unit [3], and the camera [4] section stores the firmware for the camera unit [4].

The camera unit [3] has an internal memory and a RAM, and the internal memory is provided with a camera boot section. The camera boot section stores a boot program for activating the camera unit [3]. The camera unit [4] has an internal memory and a RAM, and the internal memory is provided with another camera boot section. The camera boot section stores a boot program for activating the camera unit [4].

And when the camera unit [3] is attached to the main body unit [1], the main body unit [1] determines that the firmware for the camera unit [3] is not installed in the camera unit [3] at the first specification value exchange, as well as loads the information of the main body common section and the camera [3] specific section to the RAM to activate the main body unit [1]. On the other hand, in the camera unit [3], the information of the camera boot section is loaded to the RAM to activate the camera unit [3].

After the main body unit [1] and the camera unit [3] are activated, when the power supply is on, the firmware for the camera unit [3] is loaded from the camera [3] section in the main body unit [1] to the RAM in the camera unit [3] to start the operation as the camera system.

And when the camera unit [4] is attached to the main body unit [1], the main body unit [1] determines that the firmware for the camera unit [4] is not installed in the camera unit [4] at the first specification value exchange, as well as loads the information of the main body common section and the camera [4] specific section to the RAM to activate the main body unit [1]. On the other hand, in the camera unit [4], the information of the camera boot section is loaded to the RAM to activate the camera unit [4].

After the main body unit [1] and the camera unit [4] are activated, when the power supply is on, the firmware for the camera unit [4] is loaded from the camera [4] section in the main body unit [1] to the RAM in the camera unit [4] to start the operation as the camera system.

In this manner, in the camera system of Embodiment 2, pieces of the firmware for the main body unit [1] are installed to the camera unit [3] and the camera unit [4], respectively, thus reducing the distribution of the firmware.

In addition, since the internal memory of the camera units [3] and [4] can be simplified, the camera units [3] and [4] can be implemented with a low cost.

### Embodiment 3

Embodiment 3 is configured such that operations can be performed by switching between Embodiment 1 and Embodiment 2.

That is to say, in Embodiment 3, if the firmware for the main body is found (exists) in step S14 of FIG. 10, the processing of step S15, and steps 17 to 19 is performed, while the processing of steps 25 to 27 is performed if the firmware for the main body is found (exists) in step S24 of FIG. 11. On the other hand, if the firmware for the main body is not found (does not exist) in step S14 of FIG. 10, the processing of steps 31 to 34 of FIG. 15 is performed, while the processing of steps 41 to 45 of FIG. 16 is performed if the firmware for the main body is not found (does not exist) in step S24 of FIG. 11.

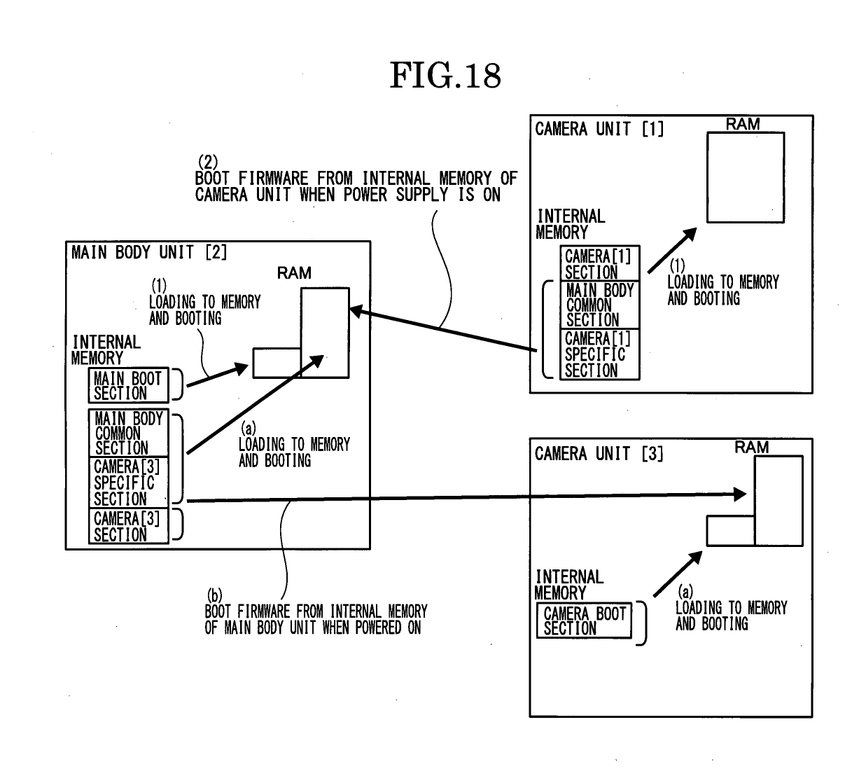

FIG. 18 shows the characteristic features of the camera system according to Embodiment 3, and shows the respective internal configurations of a main body unit [2] and camera units [1] and [3], which are external units. Here, the camera unit [1] or the camera unit [3] can be attached to the main body unit [2] in a switchable manner.

The main body unit [2] has an internal memory and a RAM, and the internal memory is provided with a main body boot section, a main body common section, a camera [3] specific section, and a camera [3] section. The main body boot section stores a boot program for activating the main body unit [1]. The configuration is such that if the main body unit [1] is activated alone without connecting the camera units [1] and [3] thereto, only replay function may be operated. Also, the main body common section stores the firmware for operating specific devices such as an operation section or a display section of the main body unit [2]. The camera [3] specific section stores the firmware specific to the camera unit [3], to which the display data, the operation sequence, and the like for the camera unit [3] are registered. The camera [3] section stores the firmware for the camera unit [3].

The camera unit [1] is the same as the camera unit [1] of FIG. 14B described in Embodiment 1. Also, the camera unit [3] is the same as the camera unit [3] of FIG. 17 described in Embodiment 2.

And when the camera unit [1] is attached to the main body unit [2], the main body unit [2] determines that the firmware for the camera unit [1] is installed in the camera unit [1] at the first specification value exchange, as well as loads the information of the main body boot section to the RAM to activate the main body unit [2]. On the other hand, in the camera unit [1], the firmware for the camera unit [1] is loaded to the RAM to activate the camera unit [1].

After the main body unit [2] and the camera unit [1] are activated, when the power supply is on, the firmware for the main body unit [2] is loaded from the main body common section and the camera [1] specific section in the camera unit [1] to the RAM in the main body unit [2] to start the operation as the camera system.

And when the camera unit [3] is attached to the main body unit [2], the main body unit [2] determines that the firmware for the camera unit [3] is installed in the camera unit [3] at the first specification value exchange, as well as loads the information of the main body common section and the camera [3] specific section to the RAM to activate the main body unit [2]. On the other hand, in the camera unit [3], the boot program for the camera unit [3] is loaded to the RAM to activate the camera unit [3].

After the main body unit [2] and the camera unit [3] are activated, when the power supply is on, the firmware for the camera unit [3] is loaded from the camera [3] specific section in main body unit [2] to the RAM in the camera unit [3] to start the operation as the camera system.

According to Embodiment 3, the operation is performed by switching between Embodiment 1 and Embodiment 2. Thus, not only the camera units [1] and [3] but also other multiple types of external units can be attached to the main body unit [2].

According to the above-mentioned configuration, a control program for the main body unit is provided to an external unit (for example, a lens unit), thus the registration content in the firmware of the main body unit can be made small in quantity. Also, the control program for the main body unit provided in the external unit is downloaded and executed. Thus, even when the firmware of the main body unit is required to be updated, upgrading only the version of the firmware of the external unit will suffice.

According to the embodiments of present invention, in a camera system in which an external unit other than a lens unit is connectable to a main body unit, a memory of the main body unit can have a capacity made as small as a required minimum capacity, and even if a new external unit is released, the operational program for the new external unit does not have to be installed in the main body unit.

Although the embodiments of the present invention have been described above, the present invention is not limited thereto. It should be appreciated that variations may be made in the embodiments described by persons skilled in the art without departing from the scope of the present invention.

The present application is based on and claims priority from Japanese Patent Application No. 2009-255925, filed on Nov. 9, 2009, and Japanese Patent Application No. 2010-143917, filed on Jun. 24, 2010, the disclosures of which are hereby incorporated by reference in their entirety.

1. A camera system comprising:
a main body unit having a storage unit configured to store image data outputted from an image pickup device, a display unit configured to display the image data, and an attachment section to which an external unit is detachably attached; and
a lens unit having an optical lens and an image pickup device, the lens unit being attachable as the external unit to the attachment section, the image pickup device configured to capture subject light having passed through the optical lens, and to output the subject light as image data, wherein
the external unit is provided with a control program to function the main body unit as a master or a slave for the external unit.

2. The camera system according to claim 1, wherein
the main body unit and the external unit each have a specification value for exchanging unit information between the main body unit and the external unit, and
on the basis of the specification value, the main body unit determines a type of the external unit attached to the attachment section.

3. The camera system according to claim 1, wherein
the main body unit loads a control program provided in the external unit and starts an operation according to the control program.

4. The camera system according to claim 2, wherein
the main body unit loads a control program provided in the external unit and starts an operation according to the control program.

5. The camera system according to claim 1, wherein
the external unit is a hard disk unit, a printer unit, a scanner unit, a projector unit, or a wireless waterproof camera unit, other than the lens unit.

6. The camera system according to claim 1, wherein
a control program to function the external unit as a master or a slave for the main body unit is provided to the main body unit, and
if a firmware for the main body unit does not exist in the external unit, the control program provided in the main body unit is loaded to start an operation according to the control program.

7. The camera system according to claim 6, wherein
if a firmware for the main body unit exists in the external unit, the control program provided in the external unit is loaded to start an operation according to the control program, and
if a firmware for the main body unit does not exist in the external unit, the control program provided in the main body unit is loaded to start an operation according to the control program.

8. A main body unit comprising:
an attachment section to which a lens unit of a camera is detachably attached;
a storage unit configured to store image data outputted from an image pickup device provided in the lens unit;
a display unit configured to display the image data; and
an operation unit configured to switch the image data displayed on the display unit, wherein
various external units instead of the lens unit are attachable to the attachment section; and
a control program to function the main body unit itself as a master or a slave for each of the external units including the lens unit is loaded from the external unit.

9. An external unit that is detachably attached to an attachment section of a main body unit of a camera, wherein
the external unit stores a control program to function the main body unit as a master or a slave for the external unit itself.

10. A control method for a camera system in which a lens unit including an image pickup device is detachably attached to an attachment section of a main body unit; various external units instead of the lens unit are attachable to the attachment section; and each of the external units including the lens unit stores a control program to function the main body unit as a master or a slave for the external unit, the method comprising, upon attachment of each of the external units to the attachment section, loading the control program from the external unit, thereby starting an operation according to the control program.
